(19) United States
(12) Patent Application Publication
(10) Pub. No.: US 2019/0293370 A1
(43) Pub. Date: Sep. 26, 2019

(54) LIGHTWEIGHT THERMAL TRANSPORT DEVICES AND METHODS

(71) Applicant: The Florida State University Research Foundation, Inc., Tallahassee, FL (US)

(72) Inventors: Zhiyong Liang, Tallahassee, FL (US); Jin Gyu Park, Tallahassee, FL (US); Nam Nguyen, Tallahassee, FL (US)

(21) Appl. No.: 16/360,210

(22) Filed: Mar. 21, 2019

Related U.S. Application Data
(60) Provisional application No. 62/645,924, filed on Mar. 21, 2018.

(51) Int. Cl. F28F 21/02; F21V 29/70

(52) U.S. Cl. CPC F28F 21/02; B82Y 30/00; F21V 29/70

(57) ABSTRACT

A heat sink for dissipating heat from a heat-generating apparatus includes one or more thermally conductive structures extending from, and in heat-conducting contact with, the heat-generating apparatus. The thermally conductive structures include sheets including carbon nanotubes, graphene, or boron nitride. The one or more thermally conductive structures are attached to the heat-generating apparatus in a configuration designed to dissipate heat from the heat-generating apparatus. Techniques for making a heat sink, and techniques of cooling a heat-generating apparatus are also described.

### CROSS-REFERENCE TO RELATED APPLICATIONS

This application claims the benefit of U.S. Provisional Patent Application No. 62/645,924, filed Mar. 21, 2018, which is incorporated herein by reference.

### STATEMENT REGARDING FEDERALLY SPONSORED RESEARCH OR DEVELOPMENT

This invention was made with government support under Contract No. SNM 1344672 awarded by the National Science Foundation. The government has certain rights in this invention.

### TECHNICAL FIELD

The disclosure describes lightweight thermal transport devices and methods, for example, heat sinks for dissipating heat from a heat-generating apparatus.

### BACKGROUND

Research and development of lightweight, high thermal conductivity materials are driven by the need for effective heat dissipation, scalability, and high performance. Many studies have been conducted to produce material designs and fabrication techniques to reduce cost and weight while maintaining performance. Several widely studied materials, such as silver nanowires, graphene, carbon nanotubes (CNTs), and boron nitride nanotubes, have demonstrated the potential to meet various thermal management device requirements. Among these materials, individual CNTs are known to have the potential to provide significantly superior properties for lightweight and high electrical/thermal conductivity with excellent mechanical properties.

However, transferring the properties of individual CNTs into macroscale products and engineering applications faces technical challenges due to their dispersion problem and fabrication technique constraints.

Numerous studies have been carried out with these nanomaterials; however, the properties of the resultant products remain significantly lower than their theoretical values. CNT films and yarn materials can be integrated to make macroscale devices and products, such as hybrid composites and sensors. For example, various applications using CNT sheets have been reported that exhibit multifunctional properties and can be used for actuators or electromagnetic interference shielding. These techniques have demonstrated the capability of transferring nanostructure properties for use in potential engineering applications.

Affordable and effective heat transfer thermal devices are important for the electronic industry because of the need for increased power and dense packing in electronic devices. CNT based composites are becoming a popular research topic for thermal management. Many researchers focus on improving the thermal conductivity of composites by functionalization, alignment, or the composition of the composites for realizing the high thermal conductivity of CNTs. Researchers have tried to utilize the excellent thermal properties of CNTs for heat sinks, thermal interface, or fillers to increase the thermal conductivity of composites. However, there remains a need for scalable processing methods to realize the properties of CNT nano structures in thermal management devices.

### SUMMARY

In some aspects, a heat sink is disclosed for dissipating heat from a heat-generating apparatus. The heat sink includes one or more thermally conductive structures extending from, and in heat-conducting contact with, the heat-generating apparatus. The thermally conductive structures include sheets including carbon nanotubes, graphene, or boron nitride. The one or more thermally conductive structures are attached to the heat-generating apparatus in a configuration designed to dissipate heat from the heat-generating apparatus.

In some aspects, a cooling fin apparatus is provided which includes a plurality of carbon nanotube sheets arranged in spaced relation to one another. The cooling fin apparatus includes a base to which a proximal edge of each of the carbon nanotube sheets is fixed, each sheet extending away from the base toward a distal edge.

In some other aspects, methods are provided for making a heat sink. The method or technique includes forming a sheet which includes a network of carbon nanotubes. The technique also includes cutting and/or folding the sheet into a configuration adapted to dissipate heat from a heat-generating apparatus.

In some other aspects, methods are provided for cooling a heat-generating apparatus. The method or technique includes operating the apparatus to produce heat. The technique also includes cooling the apparatus by conducting the heat away from the apparatus via one or more thermally conductive structures extending from, and in heat-conducting contact with, the apparatus. The thermally conductive structures include sheets including carbon nanotubes, graphene, or boron nitride.

### BRIEF DESCRIPTION OF THE DRAWINGS

FIG. 1 is a conceptual diagram illustrating a perspective view of one example of a heat sink for dissipating heat from a heat-generating apparatus.

FIG. 2 is a flow diagram illustrating one example of a technique of making a heat sink.

FIG. 3 is a flow diagram illustrating one example of a technique of cooling a heat-generating apparatus.

FIG. 4A depicts scanning electron microscopy (SEM) images of a continuous buckypaper, made according to one embodiment using a continuous process (sometime referred to herein as an “in house” process). FIG. 4B depicts SEM images of a carbon nanotube (CNT) sheet produced by a floating catalyst CVD method.

FIGS. 5A to 5C are graphs depicting a comparison of CNT sheets and buckypapers before and after heat treatment. FIG. 5A depicts thermogravimetric analysis (TGA) curves of in-house continuous buckypaper before and after heat treatment. FIG. 5B depicts TGA curves of CNT sheet from FC-CVD before and after heat treatment. FIG. 5C depicts surface areas of tested CNT sheets (buckypaper and FC-CVD CNT sheet) before and after heat treatment.

FIG. 6A depicts an experimental set up for measuring the in-plane thermal conductivity of buckypaper and CNT sheet samples, according to one embodiment. FIG. 6B is a graph which depicts in-plane thermal conductivity and thermal diffusivity of aluminum foil as baseline measurement. FIG. 6C is a graph which depicts thermal diffusivity, according to some embodiments. FIG. 6D is a graph which depicts thermal conductivity before and after the heat treatment, according to some embodiments.

FIGS. 7A, 7B, and 7D to 7G depict thermal images of a commercial light emitting diode (LED) without an attached heat sink or with different types of heat sinks attached. FIG. 7A depicts the temperature of a commercial LED without an attached heat sink. FIG. 7B depicts the LED with a commercial aluminum heat sink attached. FIG. 7C depicts an exemplary heat sink with a 4-fin design fabricated by folding and attaching CNT sheets, according to one embodiment. FIG. 7D depicts the LED with a continuous buckypaper heat sink attached, according to one embodiment. FIG. 7E depicts the LED with a heat treated continuous buckypaper heat sink attached, according to one embodiment. FIG. 7F depicts the LED with a FC-CVD CNT sheet heat sink attached, according to one embodiment. FIG. 7G depicts the LED with a graphite sheet heat sink attached, according to one embodiment.

FIGS. 8A and 8B depict heat transfer simulations of LED temperature. FIG. 8A compares simulations for heat sink materials with different thermal conductivities. FIG. 8B compares simulations for heat sink materials with different convective heat transfer coefficients.

### DETAILED DESCRIPTION

Lightweight thermal management devices and methods for fabricating lightweight thermal management devices have been developed. These advantageously can provide improved manufacturing characteristics, increased design flexibility, and large scale production. Generally, the methods used to fabricate the lightweight thermal management devices contemplate using pre-fabricated lightweight thermally conductive sheets to independently assembling lightweight thermal management devices.

In some aspects, the thermal management device is a heat sink for dissipating heat from a heat-generating apparatus. The heat sink includes one or more thermally conductive structures extending from, and in heat-conducting contact with, the heat-generating apparatus. The thermally conductive structures include sheets including carbon nanotubes, graphene, or boron nitride. The one or more thermally conductive structures are attached to the heat-generating apparatus in a configuration designed to dissipate heat from the heat-generating apparatus.

In some aspects, the thermal management device is a cooling fin apparatus including a plurality of carbon nanotube sheets arranged in spaced relation to one another. The cooling fin apparatus includes a base to which a proximal edge of each of the carbon nanotube sheets is fixed, each sheet extending away from the base toward a distal edge.

In some aspects, a technique of making a heat sink is disclosed. The technique includes forming a sheet which includes a network of carbon nanotubes, and then cutting and/or folding the sheet into a configuration adapted to dissipate heat from a heat-generating apparatus. Two or more of these sheets may be arranged together to cooperate as a heat sink.

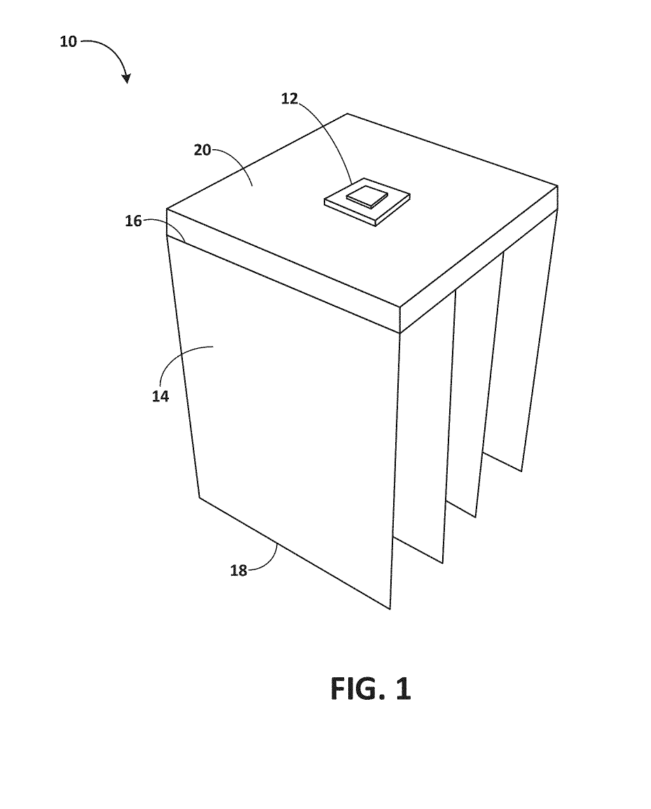

In some aspects, a technique of cooling a heat-generating apparatus is disclosed. The technique includes (i) operating the apparatus to produce heat, and (ii) cooling the apparatus by conducting the produced heat away from the apparatus via one or more thermally conductive structures extending from, and in heat-conducting contact with, the apparatus. The thermally conductive structures include sheets including carbon nanotubes, graphene, or boron nitride. FIG. 1 is a conceptual diagram illustrating a perspective view of one embodiment of a heat sink 10 for dissipating heat from a heat-generating apparatus 12. Heat sink 10 includes four thermally conductive structures 14 extending from, and in heat-conducting contact with, heat-generating apparatus 12. Thermally conductive structures 14 include sheets including carbon nanotubes, graphene, or boron nitride. In other embodiments, fewer or more thermally conductive structures may be used. The thermally conductive structures 14 are attached to heat-generating apparatus 12 in a configuration designed to dissipate heat from heat-generating apparatus 14. For example, the structures extend away from the apparatus in spaced apart relation to one another. In a preferred embodiment, thermally conductive structures 14 are metal free.

In some embodiments of heat sink 10, one or more thermally conductive structures 14 include a sheet consisting of a network of carbon nanotubes. The network of carbon nanotubes may be heat treated to reduce or remove surface impurities on the network, e.g., surfactants or additives used in processing the carbon nanotubes into sheets. In some embodiments, the carbon nanotubes of the sheet have a specific surface area in a range from about 100 m²/g to about 350 m²/g.

In some alternative embodiments of heat sink 10, one or more thermally conductive structures 14 may further include one or more thermally conductive layers fixed together with the sheets comprising carbon nanotubes, graphene, or boron nitride. For example, the thermally conductive layer may be an epoxy combined with graphite-nanoplatelets and/or carbon fibers. Thermally conductive structures 14 may be connected to essentially any heat-generating apparatus 12 in need of cooling. In particular embodiments, heat-generating apparatus 12 include electronics devices, or parts thereof, such as LEDs. In some embodiments, thermally conductive structures 14 may be directly attached to heat-generating apparatus 12 with a suitable thermally conductive paste, which is known in the art.

In some embodiments of heat sink 10, thermally conductive structures 14 are configured as cooling fins, for example, a cooling fin extending from a proximal edge 16 to a distal edge 18. For example, a plurality of cooling fins may be arranged in spaced part relation to one another, wherein at least one edge (for example, proximal edge 16) of each fin is connected to the heat-generating apparatus with the fin having a body extending away therefrom (for example, a portion between proximal edge 16 and distal edge 18).

In embodiments, heat sink 10 includes a cooling fin apparatus, and thermally conductive structures 14 include a plurality of carbon nanotube sheets. In one embodiment, cooling fin apparatus 10 includes a plurality of carbon nanotube sheets 14 arranged in spaced relation to one another, and a base 20 to which proximal edge 16 of each of carbon nanotube sheets 14 is fixed, each sheet 14 extending away from base 20 toward distal edge 18. In some preferred embodiments, carbon nanotube sheets 14 each consists of a heat treated network of multiwall carbon nanotubes. In some alternative embodiments, carbon nanotube sheets 14 include at least one layer of a heat treated network of multiwall carbon nanotubes and at least one thermally conductive layer which includes an epoxy combined with graphite-nanoplatelets and/or carbon fibers.

As used herein, the term “carbon nanotubes” and the abbreviation “CNTs” generally refer to tubular graphite, which may be capped with fullerene structures. The CNTs may be a synthetic material having a wide molecular weight range that depends substantially on the diameter and length of the CNTs. CNTs are commercially available from companies such as General Nano, LLC (Cincinnati, Ohio, USA) and Nanocomp Technologies Inc. (NH, USA), or can be made using techniques known in the art. The CNTs can be pristine, in which the carbon fullerene tubes have fullerene end caps, or the CNTs can be non-pristine, for example, where the pristine CNTs have been chemically or mechanically altered (e.g., chopped) and then optionally functionalized to convert dangling carbon atoms to different functional groups, such as carbonyl or other oxygen containing groups. The sidewalls of the CNTs also may be functionalized to include one or more functional groups. The CNTs, in embodiments, also include one or more other nanomaterials, such as graphene, metal nanoparticles, or a combination thereof. In some embodiments, the CNTs are pristine MWNTs. In some other embodiments, the CNTs are non-pristine MWNTs. In some embodiments, the CNTs include a mixture of pristine MWNTs and pristine SWNTs. In some embodiments, the CNTs include a mixture of pristine MWNTs and non-pristine SWNTs, or vice versa. In some embodiments, the CNTs are pristine SWNTs. In some embodiments, the CNTs are non-pristine SWNTs. In each of the foregoing embodiments, the sidewalls of at least a portion of the SWNTs, MWNTs, or a combination thereof may be functionalized.

The term “CNT sheet,” as used herein, refers to a macroscopic aggregate of carbon nanotubes. The CNT sheets herein generally may be in the form of a macroscale sheet (i.e., film) or strip (i.e., ribbon), and may have any dimensions suited to a particular application. For example, the CNT sheets may have a length of about 10 cm to about 10 m, a width of about 1 mm to about 12 inches, and a thickness of about 5 μm to about 50 μm. Other dimensions are envisioned, including lengths and/or widths that exceed 10 m, as well as, lengths and/or widths that are less than 1 mm. CNT sheets are available commercially, or may be formed by techniques known in the art, such as dispersing carbon nanoscale fibers in a non-solvent and filtering and/or evaporating the non-solvent.

In some embodiments, the CNT sheets, sometimes called “buckypapers”, used in the thermal management devices and methods described herein are fabricated using methods described in U.S. Pat. No. 7,459,121, which is incorporated in its entirety herein. In some other embodiments, the CNT sheets are fabricated according to other methods known in the art.

In some embodiments, the thermal management devices and methods described herein use lightweight, thermally conductive sheets selected from graphene sheets, boron nitride free-standing sheets, or combinations thereof.

The thermal management devices may be made using lightweight thermally conductive sheets having relatively large dimensions. For example, the lightweight thermally conductive sheets and/or ribbons may be made having at least one dimension of 10 cm, 0.1 m, 1.0 m, or more. These sheets and ribbons may be cut and/or folded into suitable geometries and sizes for various thermal management applications.

In some embodiments, pre-fabricated CNT sheets are used for heat dissipation purposes. Specifically, CNT sheets may be assembled to make an extremely lightweight and flexible heat sink utilizing buckypapers' high thermal conductivity and large surface area. While reported heat sinks at the microscale have been fabricated by laser-assisted surface patterning and CVD growth of vertical CNTs, the presently disclosed method can be applied for macroscale products and devices primarily due to the use of pre-fabricated large CNT sheets.

Additionally, many conventional heat management devices frequently utilized in the industry are forged or pressed close to their final dimensions, but nonetheless require machining. The presently disclosed methods for fabricating heat management devices advantageously may need less machining to finalize the devices.

In some embodiments, thermal conductivity may be increased by essentially any method that facilitates alignment of the carbon nanotubes. In some embodiments, conductivity is enhanced by mechanical means such as by stretching, rolling, pressing, or any combination thereof. Functionalization may be achieved by subjecting the CNT sheets to microwaves, plasma, electron beam, chemical functionalization, or any combination thereof. Not wishing to be bound by any particular theory, it is believed that surface functionalization techniques may improve at least one of the mechanical and/or electrical properties of CNT sheets. Functionalization of the CNT sheets may be performed at any time during, before, and/or after any of the steps of the methods described herein are performed. Not wishing to be bound by any particular theory, it is believed that improving the alignment of the carbon nano scale fibers can enhance thermal conductivity by increasing [a] the contacts between the individual carbon nanotubes, [b] the density of the packing structure of the CNT sheet, or [c] a combination thereof.

In some alternative embodiments, the techniques provided herein may include disposing a thermally conductive layer to at least a portion of a lightweight thermally conductive sheet. In one embodiment, the thermally conductive layer is disposed on at least a surface of a CNT sheet. The surface onto which the thermally conductive layer is disposed may include one, all, or any portion of the external surfaces of a CNT sheet. The thermally conductive layer may be disposed substantially evenly on at least a surface of a CNT sheet or unevenly on at least a surface of a CNT sheet. Alternatively, the thermally conductive layer may be disposed substantially evenly on a first surface of a CNT sheet, and unevenly on a second surface of a CNT sheet. For example, when the CNT sheet is a sheet or ribbon, the thermally conductive layer may be disposed substantially evenly on both sides of the sheet or ribbon. As a further example, the thermally conductive layer may be disposed unevenly on both sides of the sheet or ribbon. As yet another example, the thermally conductive layer may be disposed substantially evenly on one side of the sheet or ribbon, and unevenly on the other side of the sheet or ribbon. In an additional example, the thermally conductive layer may be disposed substantially evenly or unevenly on one side of the sheet or ribbon, and the other side of the sheet or ribbon may be substantially free of the thermally conductive layer.

The thermally conductive layer generally may be any material that [a] does not substantially impact the thermal conductivity of a CNT or other lightweight thermally conductive sheet, [b] enhances one or more properties of the CNT or other lightweight thermally conductive sheet, [c] enhances the stability, such as the air stability, of the CNT or other lightweight thermally conductive sheet, [d] enhances handling and/or processability of the CNT or other lightweight thermally conductive sheet, or [e] a combination thereof. In some embodiments, the thermally conductive layer comprises a metal free composite ink.

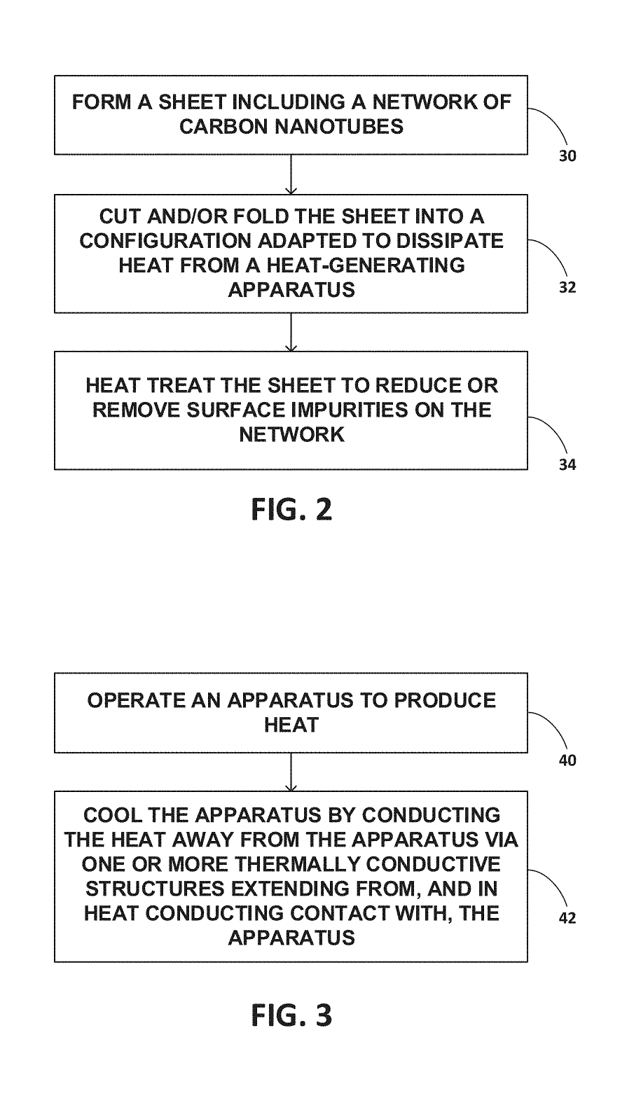

The thermally conductive layer may be disposed on the lightweight thermally conductive sheet using any techniques known in the art. In embodiments, the thermally conductive layer is disposed on the lightweight thermally conductive sheet by 3D printing. For example, disposing the thermally conductive layer on a CNT sheet may comprise 3D printing of a thermally conductive composite ink on at least a portion of the CNT sheet. The 3D printing may result in a single conductive layer on the CNT sheet, may result in multiple identical layers, may result in different conductive layers being disposed on the CNT sheet, or a combination thereof. FIG. 2 is a flow diagram illustrating one embodiment of a technique of making a heat sink. In some embodiments, the technique includes forming a sheet which includes a network of carbon nanotubes (30). The technique includes cutting and/or folding the sheet into a configuration adapted to dissipate heat from a heat-generating apparatus (32). In some embodiments, the technique further includes combining the sheet with a thermally conductive layer which includes an epoxy combined with graphite-nanoplatelets and/or carbon fibers. In some embodiments, the sheet is heat treated to reduce or remove surface impurities and surfactants from processing on the network (34).

FIG. 3 is a flow diagram illustrating one embodiment of a technique of cooling a heat-generating apparatus. In some embodiments, the technique includes operating the apparatus to produce heat (40). The technique includes cooling the apparatus by conducting the heat away from the apparatus via one or more thermally conductive structures extending from, and in heat-conducting contact with, the apparatus (42). The thermally conductive structures include sheets comprising carbon nanotubes, graphene, or boron nitride.

Thus, heat sinks or cooling fin apparatuses according to the disclosure may be used to dissipate heat from heat-generating apparatuses.

### EXAMPLES

The features and other details of the invention will now be more particularly described and pointed out in the following examples describing preferred techniques and experimental results. These examples are provided for the purpose of illustrating the invention and should not be construed as limiting.

### Example 1—Preparation of Lightweight Thermally Conductive Sheets

Continuous CNT sheets or buckypapers (BP) with an aerial density of 10 g/m² were obtained by filtering aqueous dispersion of multi-walled carbon nanotubes (MWCNTs) from General Nano, LLC and peeling the resulting sheets from the filter after washing and drying. The produced CNT sheets were then heated to 400° C. for 2 hours to remove surfactant residues.

Another type of CNT sheets, supplied by Nanocomp Technologies Inc., which are made using a floating catalyst CVD were also studied. The microstructures of the samples were observed by scanning electron microscope (SEM, JEOL JSM-7401F).

An infrared thermal camera (E40, FLIR) was used to obtain thermal images to study temperature distribution. An Abaqus™ 6.13 was used for finite element analysis (FEA) of the heat transfer of various select sample designs. In the heat transfer simulation, 8-node linear heat transfer brick (DC3D8) elements were used for meshing the model. Heat transfer was governed by EQUATION 1.

$$k [ \frac{{\partial }^{2} T}{\partial {x}^{2}} + \frac{{\partial }^{2} T}{\partial {y}^{2}} + \frac{{\partial }^{2} T}{\partial {z}^{2}} ] - hA ( T - {T}_{amb} ) = 0 \qquad ( Equation 1 )$$

where k is the thermal conductivity (W/mK), Q is the heat generation per unit volume (W/m³), h is the convective heat transfer coefficient (W/m²K), A is the area (m²) and T is the temperature (° C.).

The thermal conductivities of CNT sheets were studied using a laser flash apparatus (LFA 457 Microflash, NETSZCH, Germany) with two different holders to examine in-plane and through-thickness thermal conductivity. The thermal diffusivity (a) of the samples was measured from LFA using half-rising time of detector temperature readings. The density (p) was measured using the Archimedes method and the specific heat (Cp) was used from the literature. From a, p, and Cp, the thermal conductivity (K) was determined using EQUATION 2. Three tests for each sample type were conducted.

κ=α×ρ×Cρ (Equation 2)

A Q50 from TA Instrument Inc. (New Castle, Del., USA) was used for thermogravimetric analysis (TGA) of CNT sheets before and after heat treatment at a 10° C./min rate.

The porosity of the samples was determined using an automated gas adsorption analyzer (Quantachrome Autosorb-iQ) using nitrogen gas adsorption-desorption isotherms at 77 K. All samples were outgassed at 180° C. for 2 hours prior to testing. The Brunauer-Emmett-Teller (BET) specific surface areas were determined from the linear portion of the adsorption isotherm. The pore size distributions were calculated using the Barrett-Joyner-Halenda (BJH) method and applied to the adsorption branch of the isotherm.

### Example 2—Characterization and Heat Treatment of CNT Sheets

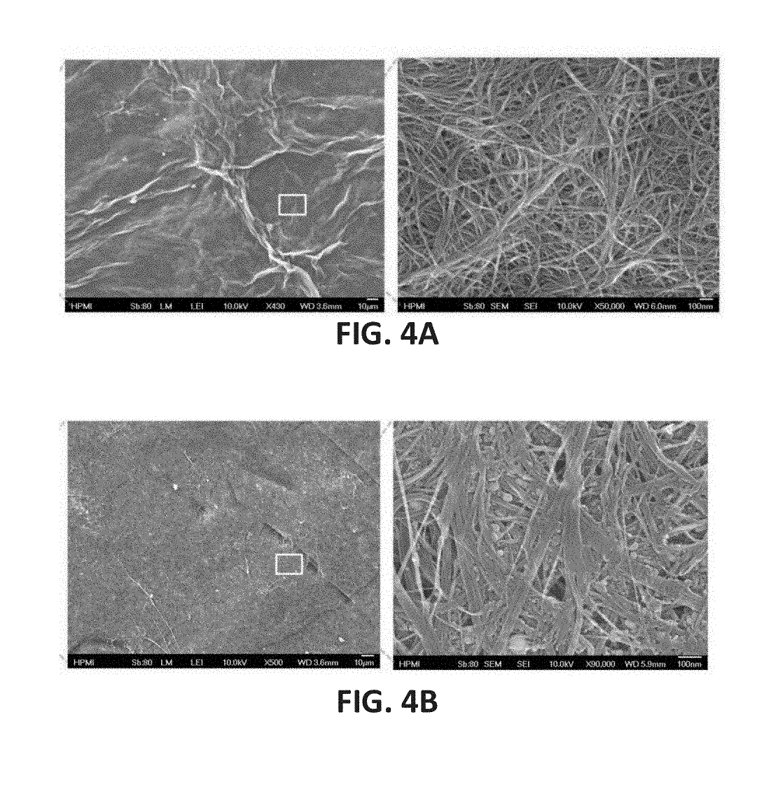

Before using the CNT sheets for sample fabrication, different post-treatment processes, including mechanical stretching, cleaning, or functionalization, can be performed on the sheets to improve their mechanical, thermal, and/or electrical properties. FIGS. 4A and 4B depict the morphology of continuous buckypaper and FC-CVD CNT sheets. FIG. 4A depicts scanning electron microscopy (SEM) images of a buckypaper made according to one embodiment using a continuous process (sometime referred to herein as an “in house” process). FIG. 4B depicts SEM images of a CNT sheet produced by a floating catalyst CVD method.

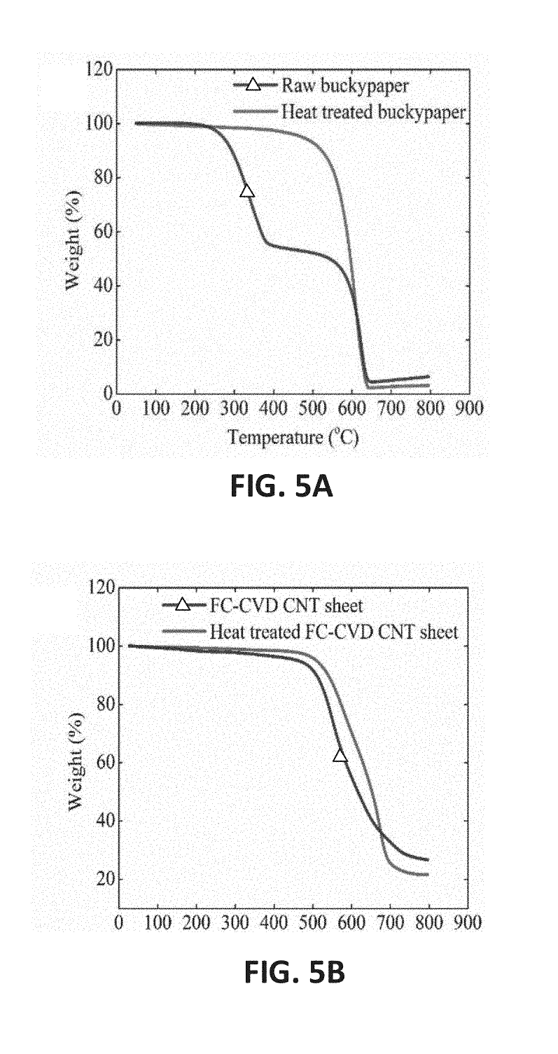

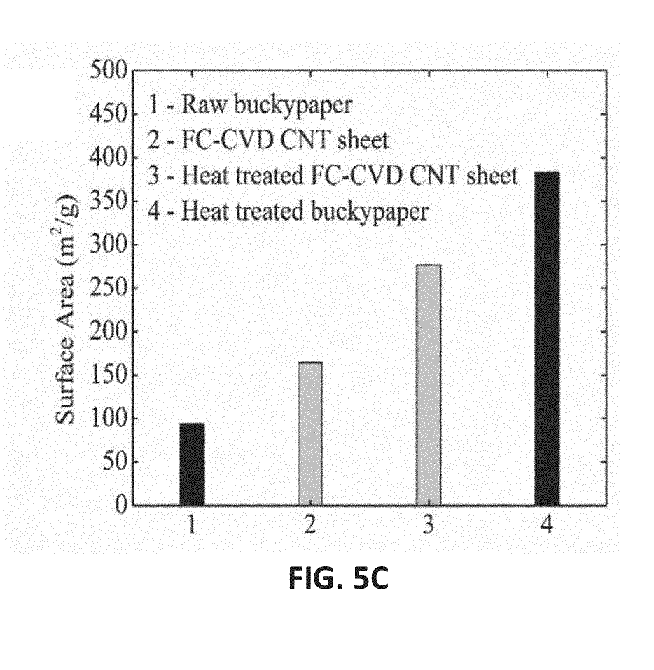

Heat treatment was used to improve the thermal conductivity of the CNT sheets due to its simplicity and suitability for large-scale fabrication. The residual surfactant in the sheets was removed after heat treatment at 400° C. for 2 hours. FIGS. 5A to 5C are graphs depicting comparisons of CNT sheets and buckypapers before and after heat treatment. FIG. 5A depicts thermogravimetric analysis (TGA) curves of in-house continuous buckypaper before and after heat treatment. FIG. 5B depicts TGA curves of CNT sheet from FC-CVD before and after heat treatment. Thus, FIGS. 5A and 5B show the TGA results of pristine and heat-treated CNT sheets. FIG. 5C depicts surface areas of tested CNT sheets (buckypaper and FC-CVD CNT sheet) before and after heat treatment.

Due to their nanometric diameter, CNTs have a very large specific surface area ranging up to 1315 m²/g, theoretically. The specific surface area of CNTs is affected by several parameters, such as type of CNT, diameter, impurities, and surface functionalization. FIG. 5C shows that the specific surface area of CNT sheets increased significantly from 100 m²/g to 350 m²/g after the heat treatment. The increase is attributed to removal of impurities and a more accessible CNT surface for nitrogen adsorption during BET measurements. After heat treatment, the CNT sheets underwent a densification process because of surfactant evaporation and shrinkage.

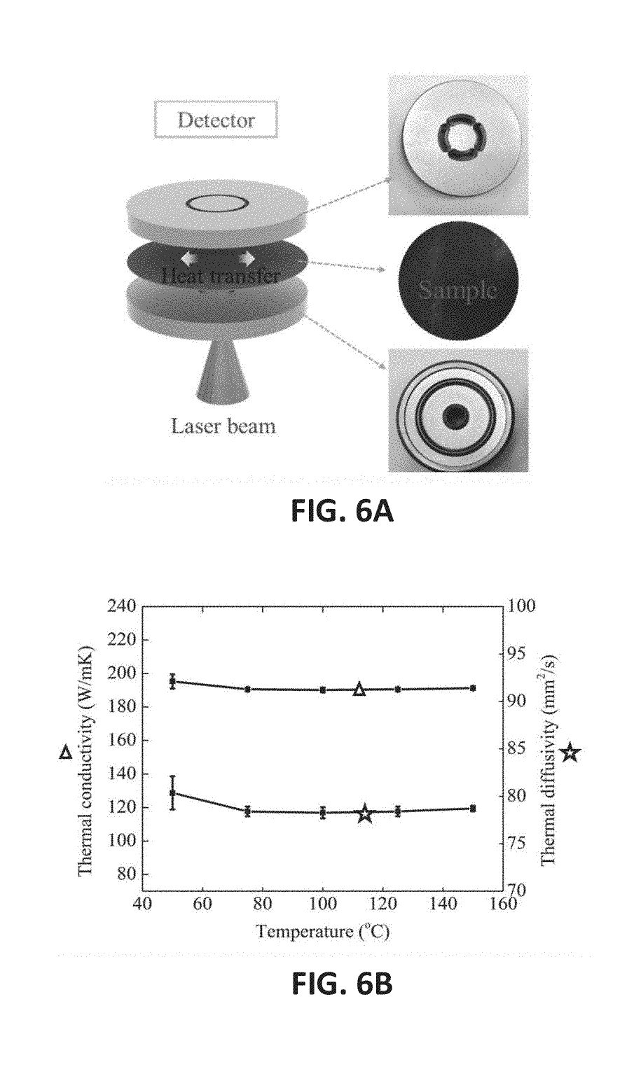

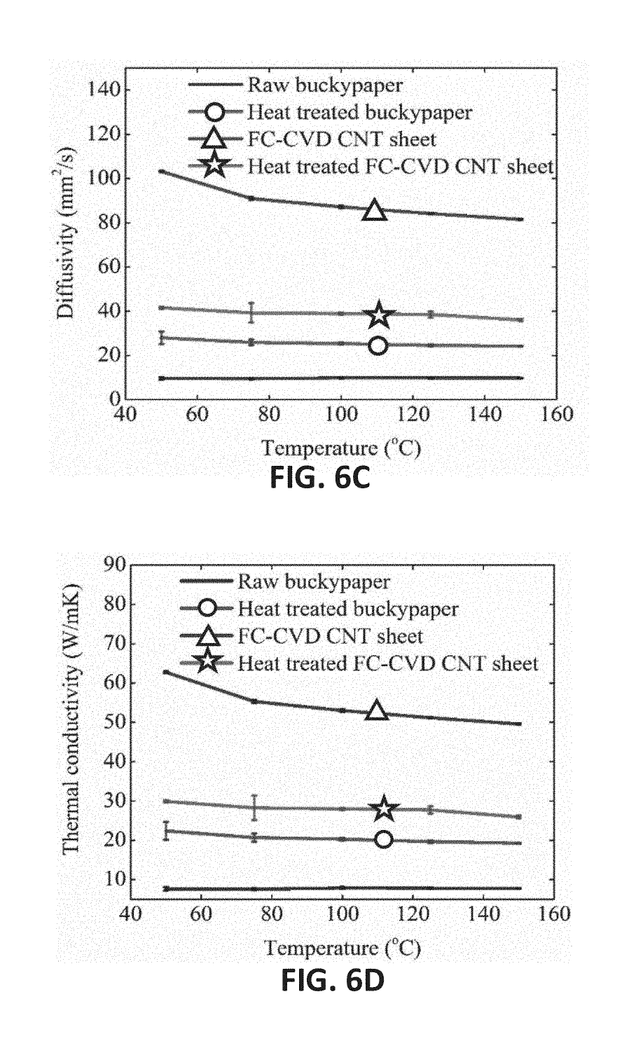

FIG. 6A depicts an experimental set up for measuring the in-plane thermal conductivity of buckypaper and CNT sheet samples, according to one embodiment. To measure the thermal conductivity of CNT sheets, a laser flash method with an in-plane sample holder was used, as shown in FIG. 6A.

FIG. 6B is a graph which depicts in-plane thermal conductivity and thermal diffusivity of aluminum foil as baseline measurement. To ensure reliability of the results, the known thermal conductivity of aluminum foil was measured as a reference, as shown in FIG. 6B. The results showed that the thermal conductivity of aluminum was ˜200 W/mK, which is consistent with literature value.

FIG. 6C is a graph which depicts thermal diffusivity, according to some embodiments. FIG. 6D is a graph which depicts thermal conductivity before and after the heat treatment, according to some embodiments. The thermal diffusivity and thermal conductivity of the continuous buckypapers were determined to be 10 mm²/s and 10 W/mK at room temperature, respectively, as shown in FIGS. 6C to 6D. After the heat treatment, the in-plane thermal conductivity of the sheets was determined to be 29 W/mK, which was ˜200% improvement at room temperature. Therefore, the heat treatment improved both the electrical and thermal transport properties of the CNT sheets. This is largely attributed to the improvement from the denser stacking of CNTs and removal of surfactant residue.

### Example 3—Assembly of CNT Sheets to Make Lightweight Heat Sinks

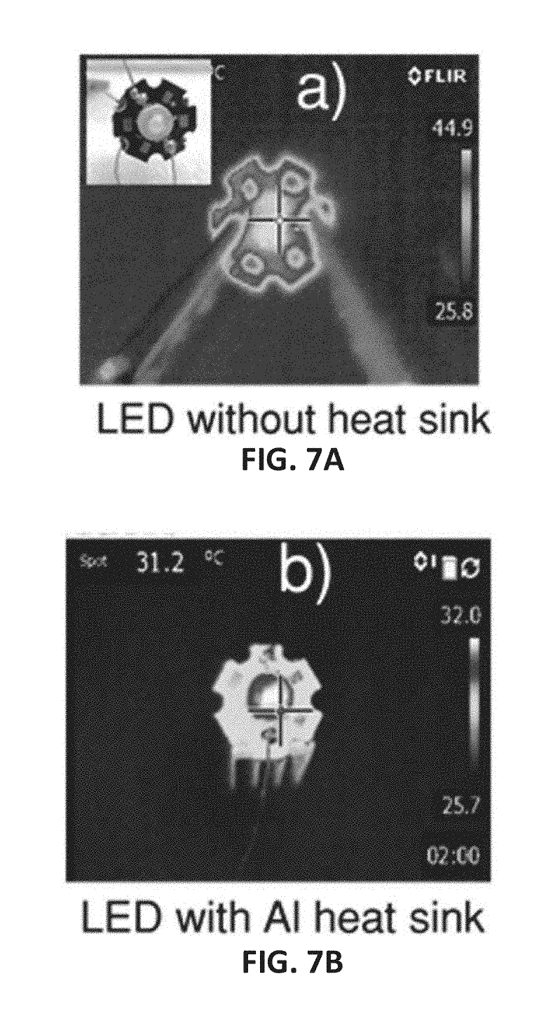

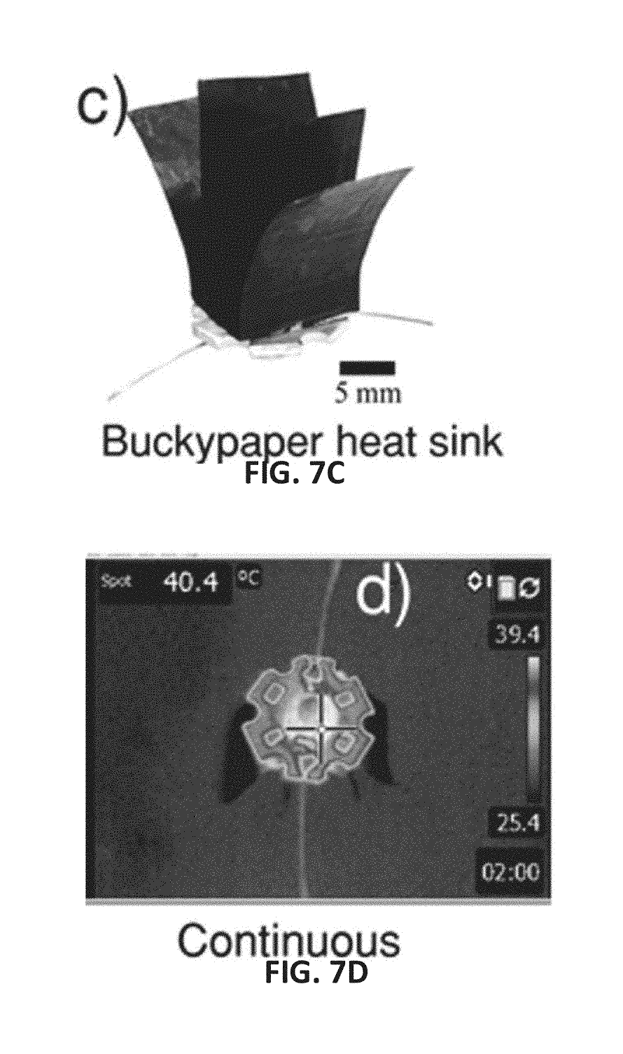

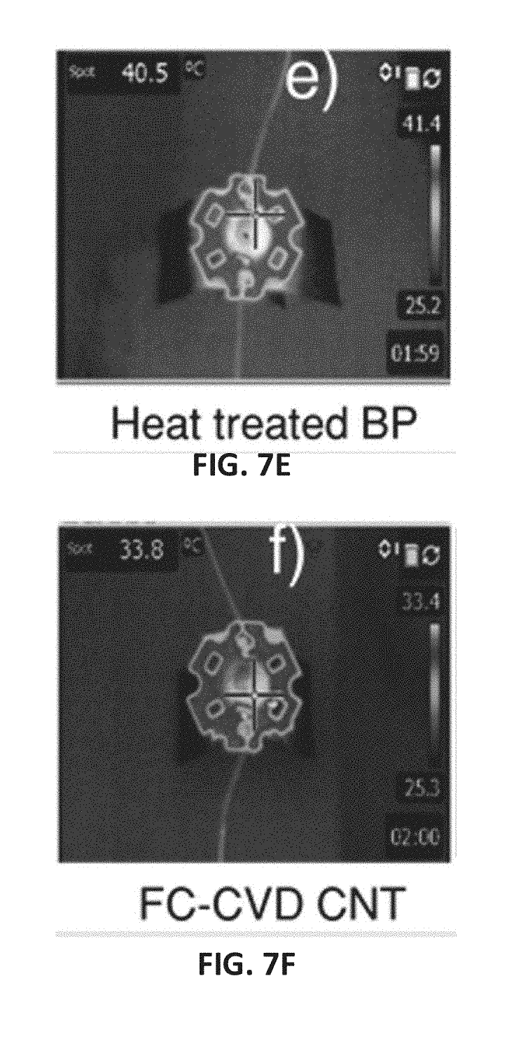

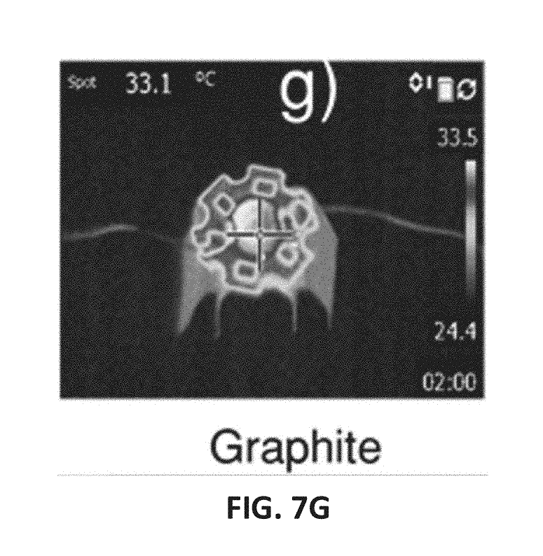

Pre-fabricated CNT sheets were used for heat dissipation purposes. Specifically, CNT sheets were assembled to make an extremely lightweight and flexible heat sink utilizing buckypapers' high thermal conductivity and large surface area. The performance of assembled buckypaper heat sinks was evaluated by monitoring the temperature of a LED. A commercial LED (1 W, 3.0-3.6V, 350 mA, White—Uxcell) with a DC bias, which requires a heat sink to dissipate heat during operation was used. FIGS. 7A, 7B, and 7D to 7G depict thermal images of a commercial LED without an attached heat sink or with different types of heat sinks attached. FIG. 7A depicts the temperature of a commercial LED without an attached heat sink, which is approximately the temperature limit of the LED. FIG. 7B depicts the LED with a commercial aluminum heat sink attached.

FIG. 7C depicts an exemplary heat sink with a 4-fin design fabricated by folding and attaching CNT sheets, according to one embodiment. A silver paste was used to mount the assembled buckypaper heat sink onto the LED, as shown in FIG. 7C. As illustrated, the heat sink consisted of four buckypaper cooling fins extending from the LED.

FIGS. 7D to 7G compare the heat dissipation capability of different types of heat sinks at the same time interval of 2 minutes. FIG. 7D depicts the LED with a continuous buckypaper heat sink attached, according to one embodiment. In particular, FIG. 7D depicts the LED temperature with an attached heat sink fabricated from a buckypaper (produce by a continuous filtration process), which was approximately 5 degrees lower than the LED without a heat sink. FIG. 7E depicts the LED with a heat treated continuous buckypaper heat sink attached, according to one embodiment. In particular, FIG. 7E depicts the LED with an attached heat sink fabricated from a heat treated buckypaper (produce by a continuous filtration process). Although, it was expected that the LED with the heat-treated buckypaper heat sink would perform better than the un-treated buckypaper heat sink, since the heat-treated buckypaper has a greater surface area and thermal conductivity, the results were almost the same. This similar performance is likely due to the difference in thermal conductivity not being sufficient to overcome the effect of the contact resistance between heat sink and LED.

For comparison, a heat sink using commercial FC-CVD CNT sheets (Nanocomp Technologies Inc.), and a heat sink using graphite sheets were tested, as shown in FIGS. 7F and 7G, respectively. FIG. 7F depicts the LED with a FC-CVD CNT sheet heat sink attached, according to one embodiment. FIG. 7G depicts the LED with a graphite sheet heat sink attached, according to one embodiment. The results show that the temperature of LED with commercial FC-CVD CNT sheets and the graphite sheets was about 2° C. higher than that of the commercial aluminum heat sink (FIG. 7B). Although the thermal conductivity of the tested FC-CVD CNT sheets was 60 W/mK, as compared with the tested graphite sheet with a thermal conductivity of 500 W/Mk, there was no apparent difference in the heat dissipation performance between heat sinks using FC-CVD CNT sheets and heat sinks using graphite sheets in the samples tested. This result elucidates the critical role of the high surface area of FC-CVD CNT sheets for improving the convective heat transfer coefficient in the heat sink applications.

### Example 4—Simulations of LED Temperature Using Different Heat Sink Materials

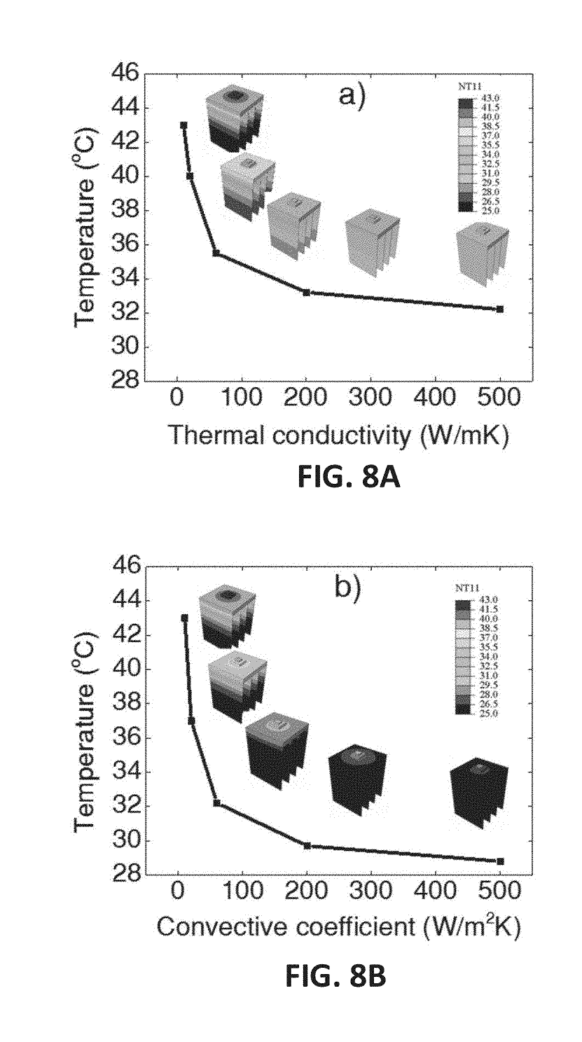

The effect of thermal conductivity and convection heat transfer coefficient on LED temperature was investigated using simulations. FIGS. 8A and 8B depict heat transfer simulations of LED temperature. FIG. 8A compares simulations for heat sink materials with different thermal conductivities. In particular, FIG. 8A depicts simulation results of LED temperature as a function of CNT sheet thermal conductivity while convective coefficient was kept constant (20 W/m²K). FIG. 8B compares simulations for heat sink materials with different convective heat transfer coefficients. In particular, FIG. 8B depicts simulation results of LED temperature as a function of CNT sheet convective coefficient while thermal conductivity was kept constant (10 W/mK). The results show that when the thermal conductivity and the convective coefficient reached a certain value, further temperature reduction was not significant. The results also show that convective coefficient has more profound effect in heat dissipation as shown in FIG. 8B. The simulations could explain why the performance of heat sinks using FC-CVD sheets (with thermal conductivity of 60 W/mK) was comparable to heat sinks using graphite sheets (with thermal conductivity of 500 W/mK) (FIGS. 7F and 7G, respectively).

In summary, these results demonstrate that making heat sinks using CNT sheets alone is possible, and the performance of such heat sinks is comparable to commercial aluminum heat sinks while weighing approximately 50 times less.

We claim:

1. A heat sink for dissipating heat from a heat-generating apparatus, the heat sink comprising:
one or more thermally conductive structures extending from, and in heat-conducting contact with, the heat-generating apparatus, wherein the thermally conductive structures comprise sheets comprising carbon nanotubes, graphene, or boron nitride,
wherein the one or more thermally conductive structures are attached to the heat-generating apparatus in a configuration designed to dissipate heat from the heat-generating apparatus.

2. The heat sink of claim 1, wherein the one or more thermally conductive structures comprise a sheet consisting of a network of carbon nanotubes.

3. The heat sink of claim 2, wherein the network of carbon nanotubes has been heat treated to reduce or remove residual processing surfactants and/or surface impurities on the network.

4. The heat sink of claim 2, wherein the carbon nanotubes of the sheet have a specific surface area from 100 m²/g to 350 m²/g.

5. The heat sink of claim 1, wherein the one or more thermally conductive structures comprise two or more cooling fins formed from a buckypaper sheet.

6. The heat sink of claim 1, wherein the heat-generating apparatus comprises one or more LEDs.

7. The heat sink of claim 1, wherein the one or more thermally conductive structures comprise a plurality of cooling fins in spaced part relation to one another, wherein at least one edge of each fin is connected to the heat-generating apparatus with the fin having a body extending away therefrom.

8. A cooling fin apparatus, comprising:
a plurality of carbon nanotube sheets arranged in spaced relation to one another, and
a base to which a proximal edge of each of the carbon nanotube sheets is fixed, each sheet extending away from the base toward a distal edge.

9. The cooling fin apparatus of claim 8, wherein the carbon nanotube sheets each consists of a heat treated network of multiwall carbon nanotubes.

10. The cooling fin apparatus of claim 8, wherein the carbon nanotube sheets comprise at least one layer of a heat treated network of multiwall carbon nanotubes and at least one thermally conductive layer which comprises an epoxy combined with graphite-nanoplatelets and/or carbon fibers.

11. A method of making a heat sink, comprising:
forming a sheet which comprises a network of carbon nanotubes; and
cutting and/or folding the sheet into a configuration adapted to dissipate heat from a heat-generating apparatus.

12. The method of claim 11, further comprising heat treating the sheet to reduce or remove surface impurities on the network.

13. The method of claim 11, wherein the configuration comprises a plurality of cooling fins.

14. A method of cooling a heat-generating apparatus, comprising:
operating the apparatus to produce heat; and
cooling the apparatus by conducting the heat away from the apparatus via one or more thermally conductive structures extending from, and in heat-conducting contact with, the apparatus,
wherein the thermally conductive structures comprise sheets comprising carbon nanotubes, graphene, or boron nitride.
